(19) United States
(12) Patent Application Publication
(10) Pub. No.: US 2015/0242142 A1
(43) Pub. Date: Aug. 27, 2015

(54) DATA TRANSFER CONTROL DEVICE AND METHOD FOR CONTROLLING DATA TRANSFER

(71) Applicant: FUJITSU LIMITED, Kawasaki-shi (JP)

(72) Inventor: Yusuke Inai, Kawasaki (JP)

(73) Assignee: Fujitsu Limited, Kawasaki (JP)

(21) Appl. No.: 14/563,051

(22) Filed: Dec. 8, 2014

(30) Foreign Application Priority Data
Feb. 24, 2014 (JP) 2014-033236

(51) Int. Cl. G06F 3/06

(52) U.S. Cl. CPC G06F 3/0619; G06F 3/065; G06F 3/0682

(57) ABSTRACT

A data transfer control device includes a processor. The processor is configured to measure a data transfer performance for each number of destination recording media. The data transfer performance is a performance for copying test data from a first storage device to a second storage device connected to the first storage device through a line. The destination recording media are included in the second storage device and serve as copy destinations of the copying. The processor is configured to determine a first number of destination recording media on basis of the data transfer performance measured for each number of destination recording media. The processor is configured to control a remote copy of copying data from the first storage device to the second storage device. The remote copy is performed by using the first number of destination recording media.

### CROSS-REFERENCE TO RELATED APPLICATION

This application is based upon and claims the benefit of priority from the prior Japanese Patent Application No. 2014-033236 filed on Feb. 24, 2014, the entire contents of which are incorporated herein by reference.

### FIELD

The embodiments discussed herein are related to a data transfer control device and a method for controlling data transfer.

### BACKGROUND

A backup process using, for example, a tape medium is known to include a remote copy process in which data stored in a virtual tape device installed in a data center is copied to a virtual tape device installed in a different data center located in a remote place. A virtual tape device (copy destination virtual tape device) serving as a destination of data copy includes a tape device for remote copy such that the remote copy process does not affect the business of the data center (copy destination data center) serving as a destination of the remote copy. A virtual tape device (copy source virtual tape device) serving as a source of data copy copies data to the tape device for remote copy first. The copy destination virtual tape device copies data from the tape device for remote copy to a tape device for backup at a time when the business of the copy destination data center is not affected.

In general, in a backup process of a tape medium, when data is divided and copied into a plurality of tape media rather than copying a large amount of data to a single tape medium, a processing time for the copying may be shortened. Therefore, the copy source virtual tape device increases the number (multiplicity level) of processing performed in parallel in the remote copy process to improve the processing performance.

Since the copy source virtual tape device and the copy destination virtual tape device transmit and receive data to and from each other using a communication line, data is allowed to be transmitted and received only within a range of a line band so that it is unable to obtain an expected processing performance even though the multiplicity level of remote copy process is increased unnecessarily.

Since the remote copy process is performed outside business hours to back up data generated during business hours, a user secures a line band with which the remote copy process of an estimated amount of backup data may be completed within a predetermined working hours.

Since a cost of the line band increases depending on its magnitude, preparing a larger line band more than necessary is inappropriate in terms of cost reduction. In order to efficiently use the line band, the virtual tape device is required to perform a remote copy process with an optimum multiplicity level.

Related techniques are disclosed in, for example, Japanese Laid-Open Patent Publication No. 2010-117992 and Japanese Laid-Open Patent Publication No. 2013-54570.

### SUMMARY

According to an aspect of the present invention, provided is a data transfer control device including a processor. The processor is configured to measure a data transfer performance for each number of destination recording media. The data transfer performance is a performance for copying test data from a first storage device to a second storage device connected to the first storage device through a line. The destination recording media are included in the second storage device and serve as copy destinations of the copying. The processor is configured to determine a first number of destination recording media on basis of the data transfer performance measured for each number of destination recording media. The processor is configured to control a remote copy of copying data from the first storage device to the second storage device. The remote copy is performed by using the first number of destination recording media.

The objects and advantages of the invention will be realized and attained by means of the elements and combinations particularly pointed out in the claims. It is to be understood that both the foregoing general description and the following detailed description are exemplary and explanatory and are not restrictive of the invention, as claimed.

Since execution environments of a remote copy process are extensive, the virtual tape device is not able to obtain an appropriate multiplicity level of a remote copy process with a sufficient accuracy. Therefore, the line band is not effectively used in a remote copy process.

### BRIEF DESCRIPTION OF DRAWINGS

FIG. 1 is a diagram illustrating an exemplary configuration of a data transfer control device according to a first embodiment;

FIG. 2 is a diagram illustrating an exemplary configuration of a data transfer system according to a second embodiment;

FIG. 3 is a diagram illustrating examples of processing sequences of a transfer performance measurement process and a remote copy process according to a second embodiment;

FIG. 4 is a diagram illustrating an exemplary hardware configuration of a virtual tape device according to a second embodiment;

FIG. 5 is a diagram illustrating an example of an LV information table according to a second embodiment;

FIG. 6 is a diagram illustrating an example of an LV group information table according to a second embodiment;

FIG. 7 is a flowchart illustrating a transfer performance measurement process according to a second embodiment;

FIG. 8 is a diagram illustrating an example of a transfer performance data table according to a second embodiment;

FIG. 9 is a diagram illustrating an example of a transfer performance data table according to a second embodiment;

FIG. 10 is a diagram illustrating an example of an LV information table according to a second embodiment;

FIG. 11 is a diagram illustrating an example of an LV group information table according to a second embodiment;

FIG. 12 is a flowchart illustrating a remote copy process according to a second embodiment; and

FIG. 13 is a diagram illustrating an example of a remote copy information table according to a second embodiment.

### DESCRIPTION OF EMBODIMENTS

Hereinafter, descriptions will be made on embodiments in detail with reference to the accompanying drawings.

### First Embodiment

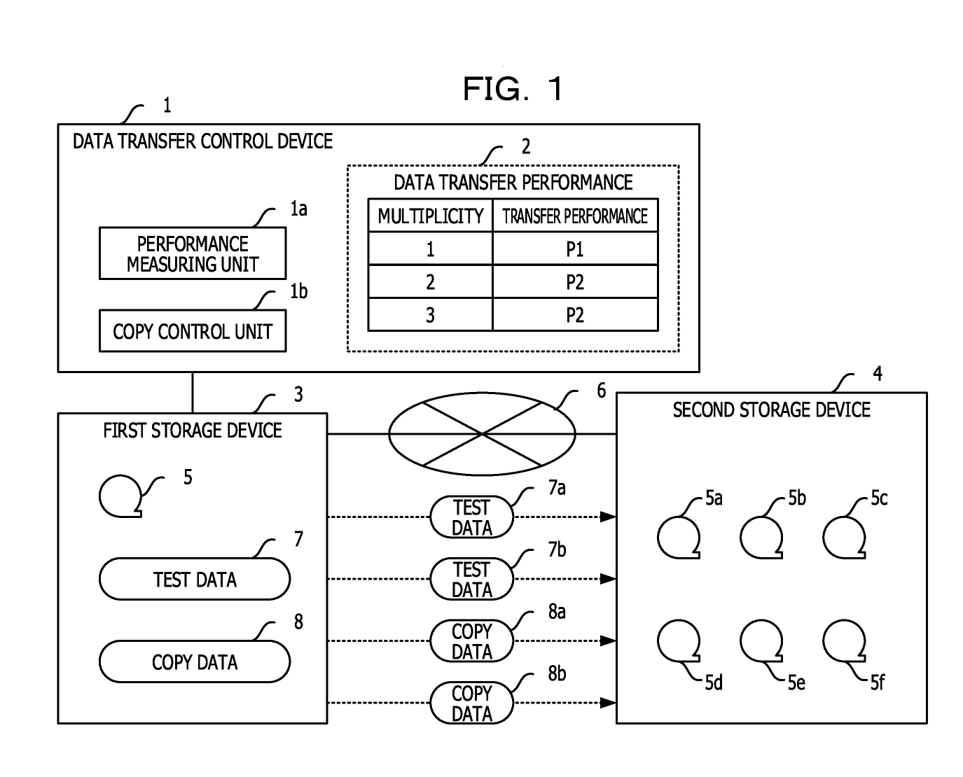

A communication system according to a first embodiment will be described first with reference to FIG. 1. FIG. 1 is a diagram illustrating an exemplary configuration of a data transfer control device according to the first embodiment.

A data transfer control device 1 controls a data transfer from a first storage device 3 to a second storage device 4. The first storage device 3 and the second storage device 4 are connected with each other through a line 6. The second storage device 4 is a destination to which data maintained in the first storage device 3 is backed up. For example, the second storage device 4 is located in a remote place from the first storage device 3. Data transfer performed by the data transfer control device 1 includes a remote copy performed through the line 6.

The first storage device 3 includes a recording medium 5 in which data may be maintained. The recording medium 5 may be, for example, a tape medium, but is not limited thereto. The second storage device 4 includes a plurality of recording media 5 (recording media 5a to 5f).

The data transfer control device 1 includes a performance measuring unit 1a and a copy control unit 1b. The performance measuring unit is measures a data transfer performance 2 prior to performing data transfer from the first storage device 3 to the second storage device 4. The data transfer from the first storage device 3 to the second storage device 4 is restricted by a communication speed depending on bandwidth of the line 6.

Further, the data transfer from the first storage device 3 to the second storage device 4 is restricted by a data writing capability of the second storage device 4. The second storage device 4 has a larger data writing capability as the number (multiplicity level) of recording media serving as a copy destination becomes larger, but has a limitation (performance limit) restricted by the bandwidth of the line 6. That is, the data transfer performance is restricted by the bandwidth of the line 6 as well as the multiplicity level of the copy destination.

A performance measuring unit is measures a data transfer performance depending on the number of the recording media 5 serving as the copy destination in the second storage device 4 using test data 7. For example, the performance measuring unit is performs a remote copy by setting the recording medium 5a as a copy destination of test data 7a and 7b and measures data transfer performance in multiplicity level “1”. Further, the performance measuring unit is performs a remote copy by setting the recording medium 5a and the recording medium 5b as copy destinations of the test data 7a and the test data 7b, respectively, and measures data transfer performance in multiplicity level “2”. By doing this, the performance measuring unit is obtains the data transfer performance 2 for each number of the recording media 5 serving as the copy destinations in the second storage device 4.

The data transfer performance 2 contains a transfer performance in each multiplicity level. For example, the transfer performance in multiplicity level “1” is “P1” and the transfer performance in multiplicity level “2” is “P2”. Since the transfer performance in multiplicity level “3” is also “P2”, a bandwidth of the line 6 is effectively used in multiplicity level “2”.

The performance measuring unit is obtains data transfer performance for each multiplicity level in this example. However, the performance measuring unit is may obtain data transfer performance for, in addition to the multiplicity level, each required transfer condition such as each data size or each destination (transfer destination) to which data is transferred.

The copy control unit 1b determines, on the basis of the data transfer performance 2 measured by the performance measuring unit 1a, a multiplicity level in which copy data 8 is transferred. For example, the copy control unit 1b refers to the data transfer performance 2 and selects the number “2” as a multiplicity level of the remote copy when transfer performance “P2” is larger than transfer performance “P1”.

Since the multiplicity level indicates the number of the recording media 5 serving as the copy destination in the second storage device 4, the copy control unit 1b sets one or more recording media 5 according to the multiplicity level as the copy destination of the copy data 8 to control execution of remote copy. For example, the copy control unit 1b sets the recording medium 5a as a copy destination of copy data 8a and sets the recording medium 5b as a copy destination of copy data 8b to control execution of remote copy in multiplicity level “2”.

Accordingly, the data transfer control device 1 may perform remote copy in which the bandwidth of the line 6 is effectively used. With such a configuration, the data transfer control device 1 may achieve a reduction of processing time for the remote copy using the bandwidth of the line 6. Further, the data transfer control device 1 may achieve reduction of cost for the line 6.

### Second Embodiment

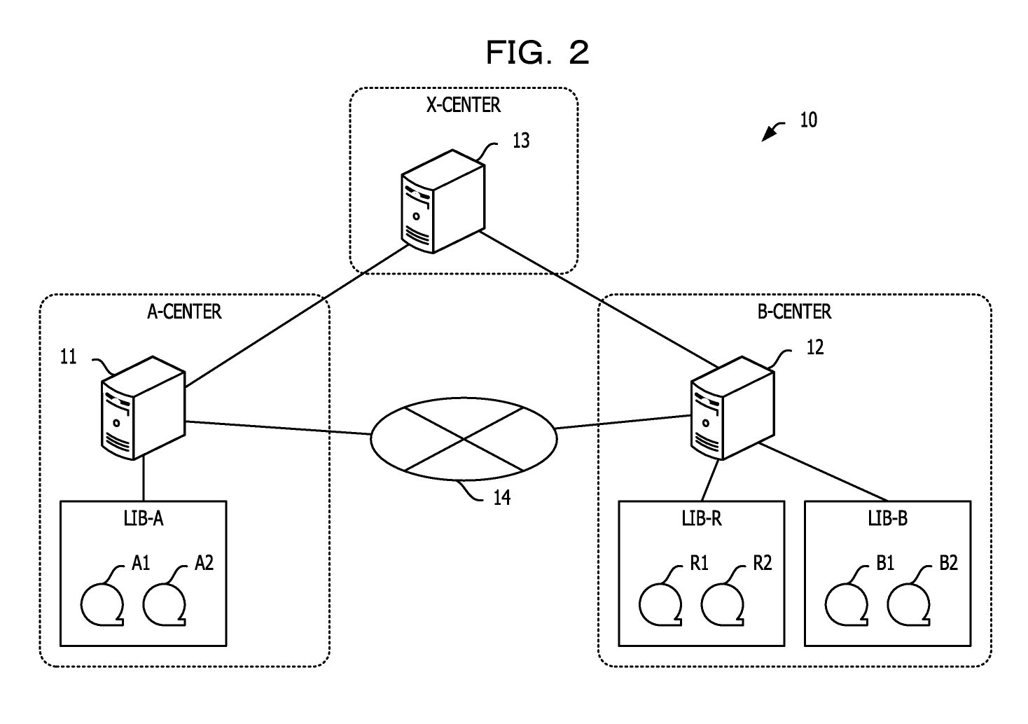

Next, a configuration of a data transfer system according to a second embodiment will be described with reference to FIG. 2. FIG. 2 is a diagram illustrating an exemplary configuration of a data transfer system according to the second embodiment.

The data transfer system 10 includes virtual tape devices 11 and 12 and a host 13 installed in three centers (A-center, B-center, and X-center), respectively. The virtual tape device 11 is installed in A-center, the virtual tape device 12 is installed in B-center and the host 13 is installed in X-center. A-center and B-center are located at remote places away from each other, and the virtual tape device 11 and the virtual tape device 12 are connected with each other through wavelength division multiplexing (WDM) 14. The WDM 14 has a predetermined bandwidth available for communication between the virtual tape device 11 and the virtual tape device 12. The host 13 is connected with the virtual tape devices 11 and 12 through the WDM 14 or a required line different from the WDM 14. X-center may be located at any place with respect to A-center and B-center, and may be located at the same site of A-center or B-center.

The virtual tape device 11 is connected with a tape device LIB-A. LIB-A is one of storage devices which store data related to business of A-center and includes a plurality of tape media A1, A2, . . . . The virtual tape device 11 provides the host 13 with an access environment per logical volume (LV) to LIB-A.

The virtual tape device 12 is connected with a tape device LIB-R for remote copy and a tape device LIB-B. LIB-B is one of storage devices which store data related to business of B-center and includes a plurality of tape media B1, B2, . . . . LIB-R is one of storage devices which temporarily store data for remote copy and includes a plurality of tape media R1, R2, . . . . Since the virtual tape device 12 includes LIB-B and LIB-R, contention of writing data related to business of B-center and writing data for remote copy is prevented.

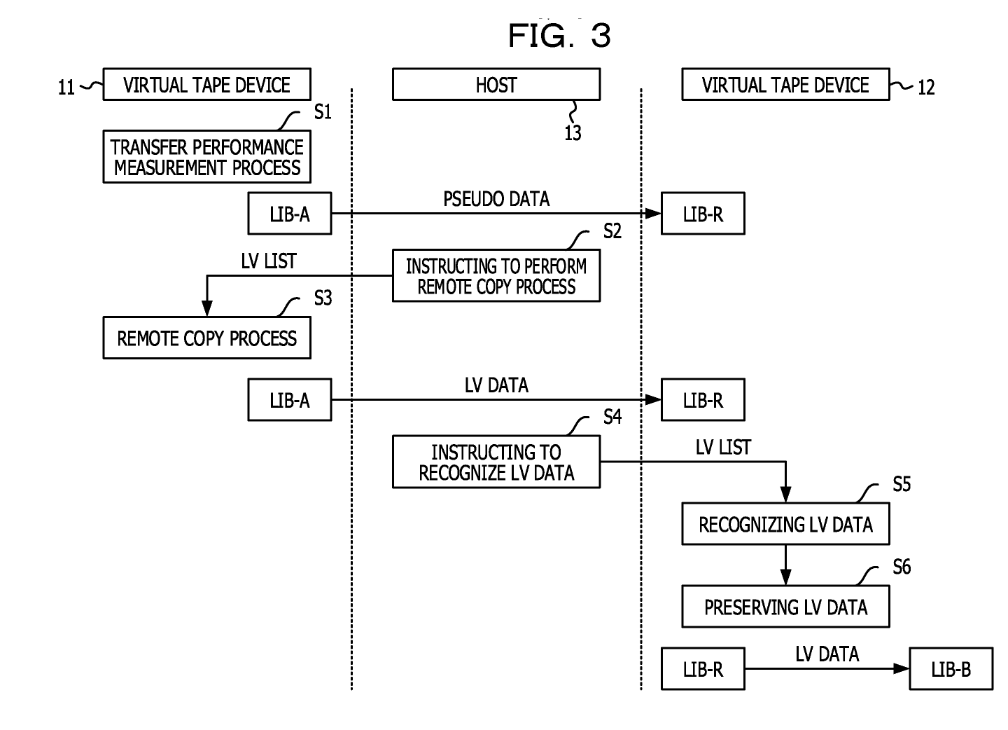

Next, descriptions will be made on processing sequences of a transfer performance measurement process and a remote copy process in a data transfer system according to the second embodiment with reference to FIG. 3. FIG. 3 is a diagram illustrating examples of processing sequences of the transfer performance measurement process and the remote copy process according to the second embodiment.

During business hours of A-center, the virtual tape device 11 accumulates data to be transferred in LIB-A. The virtual tape device 11 performs the transfer performance measurement process (S1) at a preset timing. The transfer performance measurement process (S1) is performed prior to the remote copy process. The virtual tape device 11 generates pseudo data (test data) for transfer performance measurement in the transfer performance measurement process. In the transfer performance measurement process, the virtual tape device 11 transfers the pseudo data to the virtual tape device 12 to measure transfer performance in each multiplicity level. A source (transfer source) from which the pseudo data is transferred in the virtual tape device 11 is LIB-A and a transfer destination of the pseudo data in the virtual tape device 12 is LIB-R.

The host 13 instructs the virtual tape device 11 to perform the remote copy process of copying data from LIB-A to LIB-R at a required timing (S2). The virtual tape device 11 receives, along with the instruction to perform the remote copy process, a notification of a LV list which is a list of data to be transferred in LV unit.

The virtual tape device 11 performs the remote copy process of copying data from LIB-A to LIB-R according to the LV list (S3). In the remote copy process, the virtual tape device 11 transfers data (LV data) listed in the LV list from LIB-A to LIB-R.

The host 13 receives a notification that the remote copy process is terminated from the virtual tape device 11 and instructs the virtual tape device 12 to recognize the LV data stored in LIB-R (S4). The host 13 may notify the LV list to the virtual tape device 12 to instruct the virtual tape device 12 to recognize the LV data stored in LIB-R.

The virtual tape device 12 recognizes the LV data on the basis of the LV list (S5). The virtual tape device 12 is able to access the LV data after the recognition of the LV data, but unable to access the LV data before the recognition. The virtual tape device 12 preserves, in LIB-B, the LV data stored in LIB-R (S6). The virtual tape device 12 writes the LV data into LIB-B at a timing when writing the LV data does not contend with writing data related to the business of B-center.

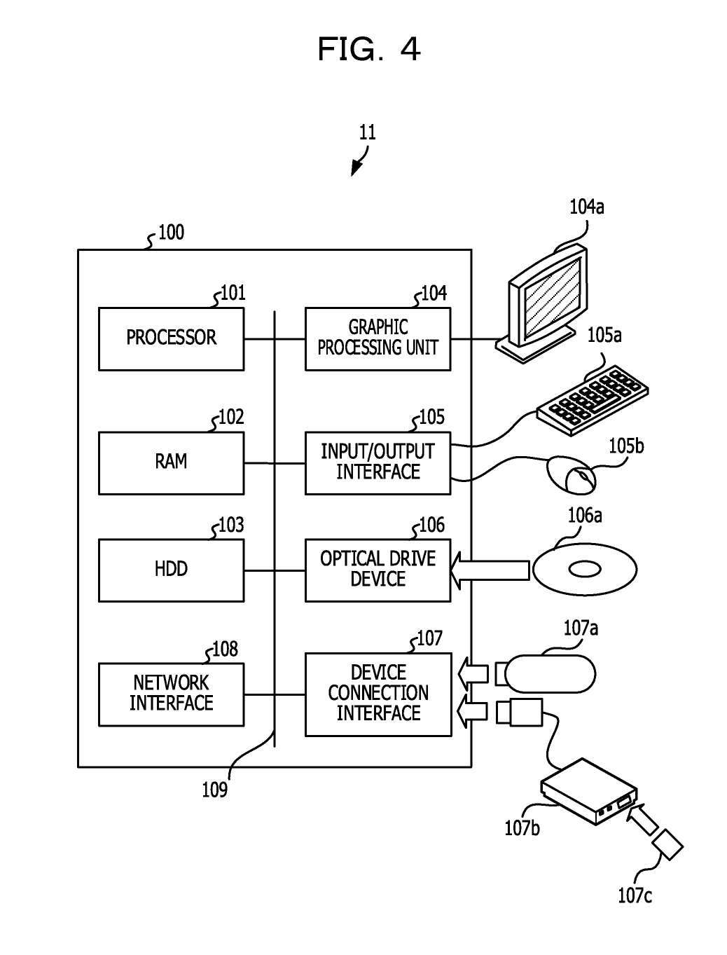

Next, a hardware configuration of the virtual tape device 11 according to the second embodiment will be described with reference to FIG. 4. FIG. 4 is a diagram illustrating an exemplary hardware configuration of a virtual tape device according to the second embodiment.

The virtual tape device 11 includes a computer 100 and a plurality of peripheral devices connected to the computer 100. The entirety of the computer 100 is controlled by a processor 101. The processor 101 is connected with a random access memory (RAM) 102 and a plurality of peripheral devices through a bus 109. The processor 101 may be a multi-processor. The processor 101 may include, for example, a central processing unit (CPU), a micro processing unit (MPU), a digital signal processor (DSP), an application specific integrated circuit (ASIC), or a programmable logic device (PLD). The processor 101 may be a combination of two or more elements among the CPU, the MPU, the DSP, the ASIC, and the PLD.

The RAM 102 is used as a main storage device of the computer 100. The RAM 102 stores therein at least a portion of an operating system (OS) program or an application program executed by the processor 101. Further, the RAM 102 stores therein various data needed for a process to be performed by the processor 101.

The peripheral devices connected to the bus 109 may include a hard disk drive (HDD) 103, a graphic processing device 104, an input/output interface 105, an optical drive device 106, a device connection interface 107, and a network interface 108.

The HDD 103 magnetically writes and reads-out data to and from a disk equipped therein. The HDD 103 is used as a secondary storage device of the computer 100. The HDD 103 stores therein the OS program, the application program and various data. A semiconductor memory such as a flash memory may also be used as the secondary storage device.

The graphic processing device 104 is connected with a monitor 104a. The graphic processing device 104 displays an image on a screen of the monitor 104a in accordance with an instruction received from the processor 101. The monitor 104a may include, for example, a display device using a Cathode Ray Tube (CRT) or a liquid crystal display device (LCD).

The input/output interface 105 is connected with a keyboard 105a and a mouse 105b. The input/output interface 105 transmits a signal sent from the keyboard 105a or the mouse 105b to the processor 101. The mouse 105b is an example of a pointing device and different types of pointing devices may be used instead. The different types of pointing devices may include, for example, a touch panel, a tablet, a touch pad, and a track ball.

The optical drive device 106 performs reading-out of data recorded in an optical disk 106a using, for example, laser light. The optical disk 106a is a portable recording medium in which data is recorded such that the data is read out by reflection of light. The optical disk 106a may include, for example, a digital versatile disc (DVD), a DVD-RAM, a compact disc read-only memory (CD-ROM) or a CD-R (recordable)/RW (rewritable).

The device connection interface 107 is a communication interface for connecting peripheral devices to the computer 100. For example, the device connection interface 107 may be connected with a memory device 107a or a memory reader/writer 107b. The memory device 107a is a recording medium equipped with a function of communicating with the device connection interface 107. The memory reader/writer 107b is a device which writes data into the memory card 107c or reads out data from the memory card 107c. The memory card 107c is a card type recording medium.

The network interface 108 is a communication interface for connecting the computer 100 with an external device. The network interface 108 transmits and receives data to and from other computer or communication equipment through a network (not illustrated).

With the hardware configuration described above, processing functions of the virtual tape device 11 according to the second embodiment may be implemented. The virtual tape device 12, the host 13, and the data transfer control device 1 according to the first embodiment may also be implemented with similar hardware to that of the virtual tape device 11 illustrated in FIG. 4.

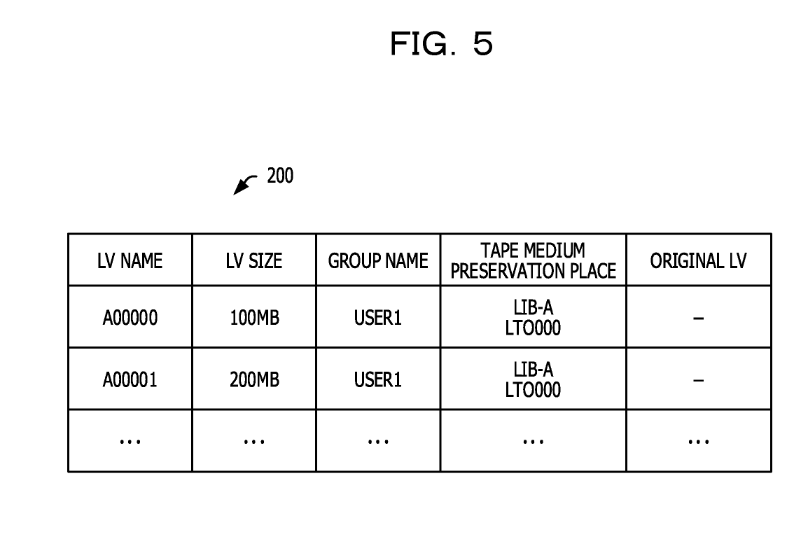

Next, descriptions will be made on management of an LV in the data transfer system 10 with reference to FIG. 5. FIG. 5 is a diagram illustrating an example of an LV information table according to the second embodiment. The virtual tape device 11 performs management of LVs using an LV information table 200. The LV information table 200 contains “LV name”, “LV size”, “group name”, “tape medium preservation place”, and “original LV” as field items. An LV name is a name given for an LV, that is, information by which the LV is identified. An LV size is a storage capacity allocated to the LV. A group name is a name given for a group (LV group) in which the LV is included, that is, information by which the LV group is identified. A tape medium preservation place is a place where data of the LV is preserved. For example, a tape device, a tape medium and a preservation location may be specified in the “tape medium preservation place” field. The “original LV” field is filled when the LV is test data. An original LV is a creation source, that is, an LV from which the test data is created.

For example, the LV information table 200 contains information regarding an LV having an LV name of “A00000” and an LV having an LV name of “A00001”. The LV information table 200 indicates that the LV A00000 has an LV size of 100 MB, is included in an LV group USER1 and is preserved in a tape medium preservation place LIB-A LTO000. “−” in the “original LV” field for the LV A00000 indicates that the LV A00000 is not test data. The same applies to the LV A00001.

The LV information table 200 is prepared as follows. The host 13 designates an LV name and a group name to transmit LV data to the virtual tape device 11. The virtual tape device 11 determines an LV size on the basis of an amount of the LV data. The virtual tape device 11 also determines a tape medium preservation place by searching for an available tape medium for preserving data.

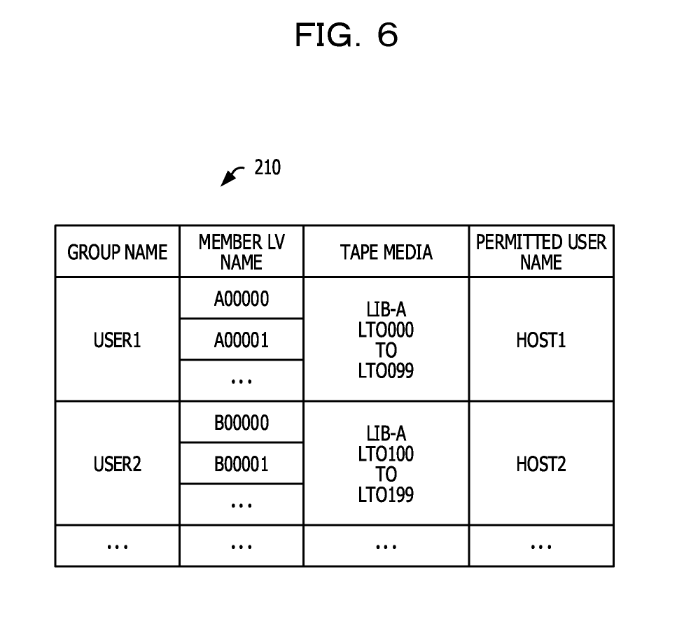

Next, descriptions will be made on management of an LV group in the data transfer system 10 with reference to FIG. 6. FIG. 6 is a diagram illustrating an example of an LV group information table according to the second embodiment. The virtual tape device 11 performs management of the LV groups using an LV group information table 210. The LV group information table 210 contains “group name”, “member LV name”, “tape media”, and “permitted user name” as field items. A group name is a name of a LV group, similar to the group name in the LV information table 200. A member LV name is a name of an LV included in the LV group. Tape media are tape media assigned to the LV group. A permitted user name is information by which a user permitted to access the LV group is identified.

For example, the LV group information table 210 contains information regarding an LV group USER1 and a LV group USER2. The LV group information table 210 indicates that the LV group USER1 includes the LV A00000, the LV A00001, . . . . The LV group information table 210 also indicates that the LVs included in the LV group USER1 are preserved in the tape media from “LIB-A LTO000” to “LIB-A LTO099”. Further, the LV group information table 210 indicates that HOST1 is permitted to access the LV group USER1. The same applies to the LV group USER2.

For example, data of the LVs included in the LV group USER1 are preserved in any one of tape media from “LTO000” to “LTO099” of LIB-A. Data of the LVs included in the LV group USER2 are preserved in any one of tape media from “LTO100” to “LTO199” of LIB-A. Accordingly, the data transfer system 10 may narrow a preservation place (tape medium preservation place) of data of the LVs on the basis of the group name.

Accessing data of the LVs included in the LV group USER1 is permitted only to the HOST1 and accessing data of the LVs included in the LV group USER2 is permitted only to the HOST2. Accordingly, the data transfer system 10 may restrict access to the LVs in LV group unit for the upper layer hosts connected to the virtual tape devices 11 and 12.

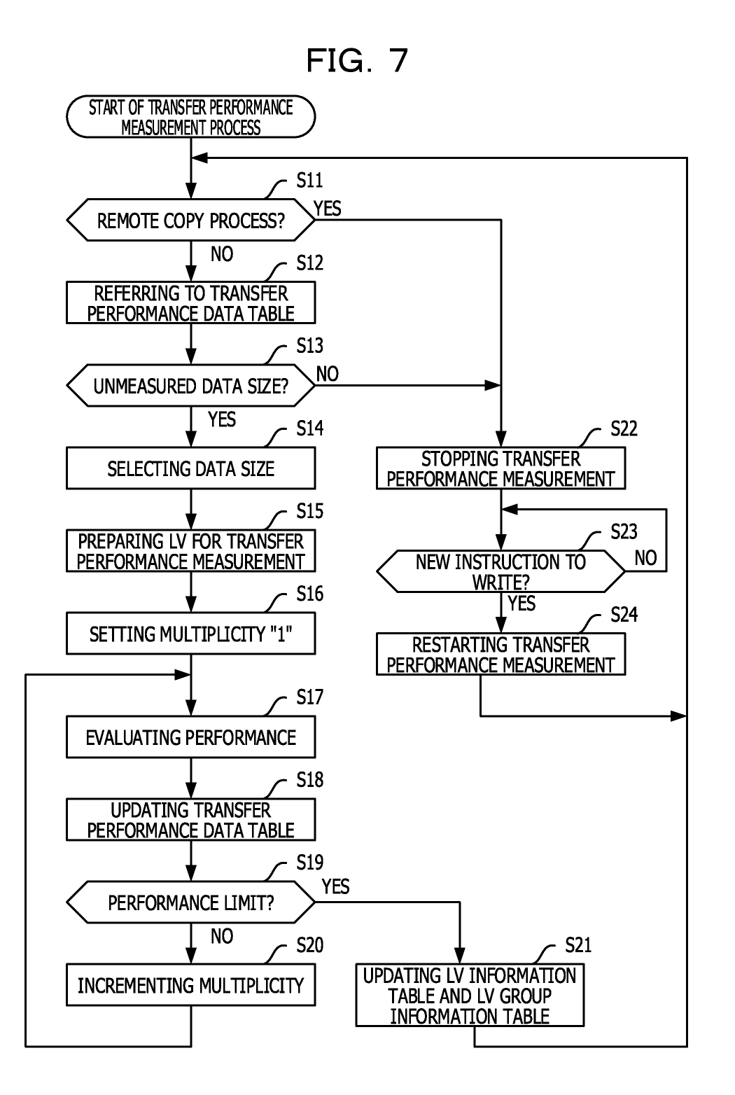

Next, descriptions will be made on a transfer performance measurement process according to the second embodiment with reference to FIG. 7. FIG. 7 is a flowchart illustrating a transfer performance measurement process according to the second embodiment. The transfer performance measurement process is a process of measuring a data transfer performance between the virtual tape device 11 serving as a data transfer source and the virtual tape device 12 serving as a data transfer destination. The transfer performance measurement process is performed by the virtual tape device 11 at a predetermined timing before the remote copy process is performed. For example, the virtual tape device 11 may perform the transfer performance measurement process during the business hours of A-center so that the transfer performance may be measured before the remote copy process is performed after the normal business hours. Therefore, the virtual tape device 11 may perform the transfer performance measurement process upon the activation of the virtual tape device 11. The activation of the virtual tape device 11 is, for example, reception of an instruction to write data to the virtual tape device 11 from the host 13. The computer 100 serves as a performance measuring unit which measures the data transfer performance.

(S11) The virtual tape device 11 determines whether the remote copy process is being performed. When it is determined that the remote copy process is being performed, the virtual tape device 11 proceeds to S22. When it is determined that the remote copy process is not being performed, the virtual tape device 11 proceeds to S12.

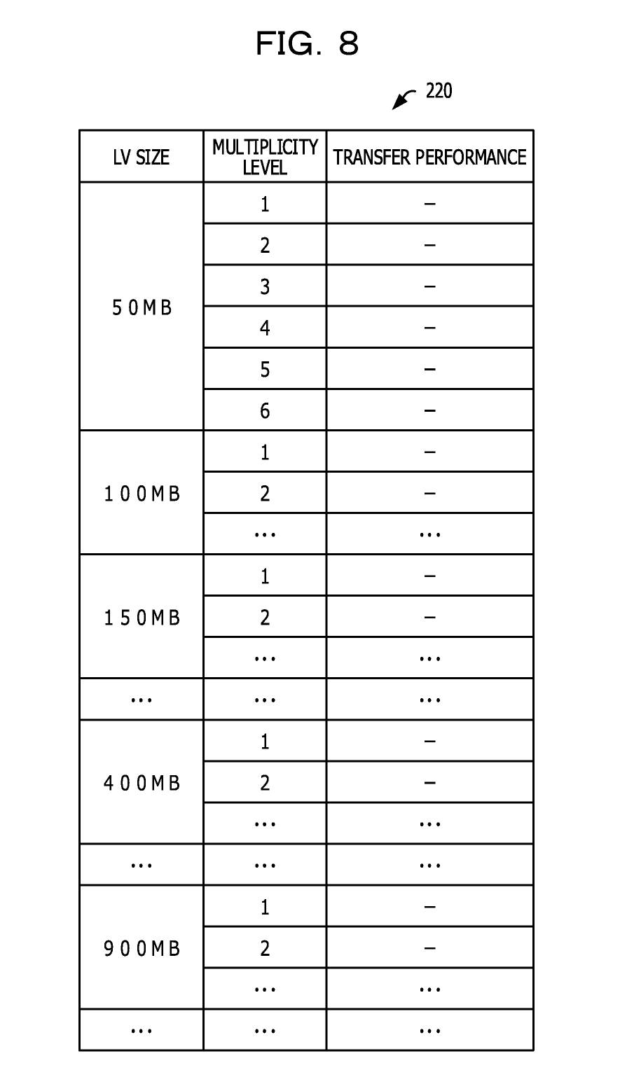

(S12) The virtual tape device 11 refers to a transfer performance data table. The transfer performance data table is a data table in which measurement values of transfer performance for each combination of parameters (an LV size and multiplicity level) are listed. An initial transfer performance data table will be described later with reference to FIG. 8.

(S13) The virtual tape device 11 determines whether a data size for which the transfer performance is not yet measured is present. When it is determined that a data size for which the transfer performance is not yet measured is present, the virtual tape device 11 proceeds to S14. When it is determined that a data size for which the transfer performance is not yet measured is not present, the virtual tape device 11 proceeds to S22.

(S14) The virtual tape device 11 selects a data size among the data sizes for which the transfer performance is not yet measured.

(S15) The virtual tape device 11 prepares an LV for transfer performance measurement. The LV for transfer performance measurement is pseudo data created based on actual data. For example, the virtual tape device 11 copies the LV A00000, which is actual data, to create an LV PF0000 which is pseudo data. The LV which is the actual data is preferably data subjected to remote copy. For example, data written into LIB-A during business hours of A-center has a high possibility of being subjected to a remote copy after the business hours of A-center. Therefore, the virtual tape device 11 may create pseudo data from data designated to be written into LIB-A by a write instruction received from the host 13 during business hours of A-center.

(S16) The virtual tape device 11 sets a multiplicity level to “1”.

(S17) The virtual tape device 11 performs performance evaluation using a data size selected at S14 along with the multiplicity level which is set currently. In the performance evaluation, pseudo data having the selected data size (LV size) is transferred to the virtual tape device 12 in the set multiplicity level. The virtual tape device 11 writes the pseudo data to LIB-R. The virtual tape device 11 obtains a measurement value of transfer performance by the performance evaluation.

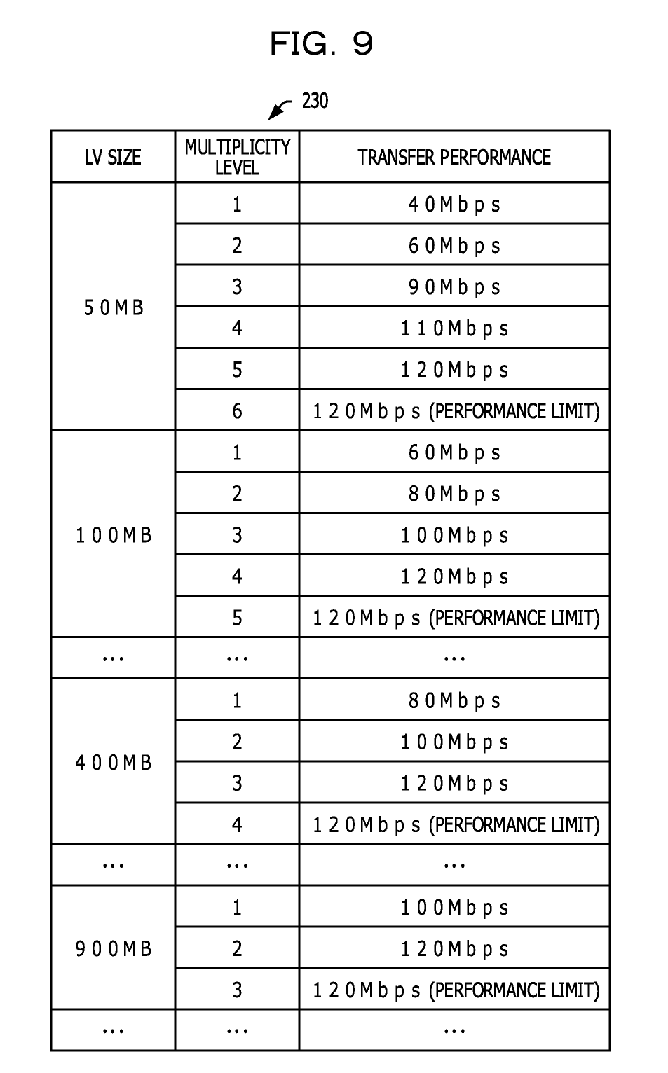

(S18) The virtual tape device 11 writes the measurement value in the transfer performance data table to update the transfer performance data table. Updating of the transfer performance data table will be described later with reference to FIG. 9.

(S19) The virtual tape device 11 determines whether the measurement value obtained at S17 is a performance limit. The performance limit is a measurement value which does not improve even though the multiplicity level is increased. When it is determined that the measurement value is the performance limit, the virtual tape device 11 proceeds to S21. When it is determined that the measurement value is not the performance limit, the virtual tape device 11 proceeds to S20.

(S20) The virtual tape device 11 increments the multiplicity level by “1” and then proceeds to S17. That is, the virtual tape device 11 finds a limitation of the measurement value while increasing the multiplicity level in increments of “1”.

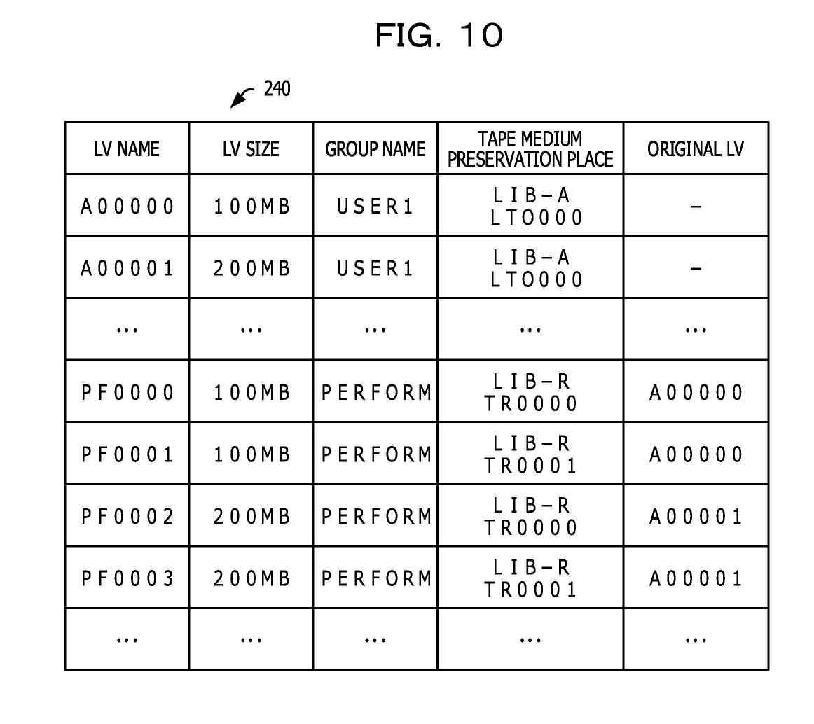

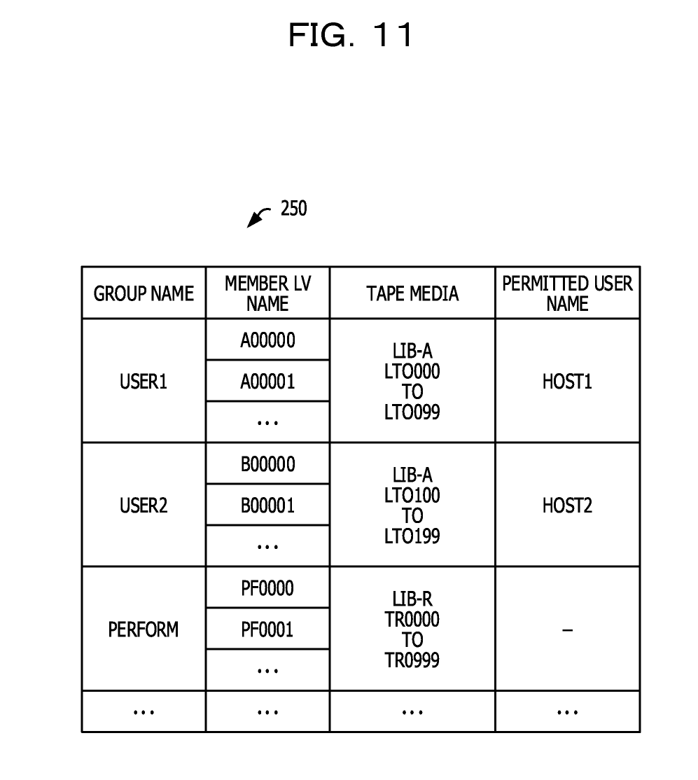

(S21) The virtual tape device 11 updates the LV information table and the LV group information table on the basis of the performance evaluation by the pseudo data transfer. Updating of the LV information table and the LV group information table will be described later with reference to FIG. 10 and FIG. 11.

(S22) The virtual tape device 11 stops the measurement of the transfer performance. That is, the virtual tape device 11 preferentially performs the remote copy process over the transfer performance measurement process.

(S23) The virtual tape device 11 determines whether a new instruction to write data is received from the host 13. The virtual tape device 11 waits for a new instruction to write data from the host 13, and when it is determined that a new instruction to write data is received from the host 13, the virtual tape device 11 proceeds to S24.

(S24) The virtual tape device 11 restarts the measurement of the transfer performance after completion of the new instruction to write data and proceeds to S11. In this case, the newly written data (LV) may be a creation source of pseudo data to be used in the transfer performance measurement.

As described above, the virtual tape device 11 measures the transfer performance before the remote copy process is performed. When the remote copy process is being performed, the virtual tape device 11 stops the measurement of the transfer performance of the remote copy process. Upon receiving from the host 13 an instruction to newly write data, the virtual tape device 11 resumes the transfer performance measurement under the condition that the remote copy process is not being performed. Accordingly, the virtual tape device 11 suppresses the transfer performance measurement from being performed while the remote copy process is performed. In order to suppress the transfer performance measurement during the remote copy process, the virtual tape device 11 may perform the transfer performance measurement by receiving an instruction to start the transfer performance measurement and an instruction to terminate the transfer performance measurement.

Next, descriptions will be made on an initial transfer performance data table with reference to FIG. 8. FIG. 8 is a diagram illustrating an example of a transfer performance data table according to the second embodiment. A transfer performance data table 220 contains “LV size”, “multiplicity level”, and “transfer performance” as field items. An LV size and a multiplicity level are parameters set in advance. The transfer performance data table 220 sets, for example, a parameter of the LV size to “50 MB”, “100 MB”, “150 MB”, . . . , “400 MB”, . . . , “900 MB” in 50 MB unit. Further, the transfer performance data table 220 sets, for example, a parameter of the multiplicity level to “1” to “6” for each LV size. The symbol “−” in the “transfer performance” field indicates that the transfer performance is not yet measured.

Next, descriptions will be made on an updated transfer performance data table with reference to FIG. 9. FIG. 9 is a diagram illustrating an example of the transfer performance data table according to the second embodiment. A measurement value of transfer performance, which is not yet measured in the transfer performance data table 220, is written in a transfer performance data table 230. In the transfer performance data table 230, for each LV size, the measurement value is written for each multiplicity level until the transfer performance associated with the multiplicity level reaches the performance limit.

For example, regarding an LV size of “50 MB”, a transfer performance associated with multiplicity level “1” is “40 Mbps”. The transfer performance is improved each time when the multiplicity level is increased until the transfer performance associated with the multiplicity level reaches a transfer performance of “120 Mbps” associated with multiplicity level of “5”. The transfer performance associated with multiplicity level of “6” is not improved as compared to the transfer performance associated with multiplicity level “5”. Accordingly, in the transfer performance data table 230, regarding the LV size of “50 MB”, the transfer performance associated with multiplicity level of “6” is regarded as the performance limit and the measurement value of the transfer performance associated with a multiplicity level which is greater than multiplicity level of “6” is not maintained. Similarly as in the matters described above regarding the LV size of “50 MB”, the measurement value is written for each multiplicity level until the transfer performance associated with the multiplicity level reaches the performance limit, for each of other LV sizes in the transfer performance data table 230.

As described above, regarding each LV size, the virtual tape device 11 writes the measurement value of the transfer performance for each multiplicity level until the transfer performance associated with the multiplicity level reaches the performance limit by performing the transfer performance measurement process. The measurement value is referenced when the remote copy process, which will be described later, is performed.

The transfer performance data table may be prepared for each required transfer condition such as each data size or each transfer destination, in addition to the multiplicity level. Next, an LV information table updated by the transfer performance measurement process is illustrated in FIG. 10. FIG. 10 is a diagram illustrating another example of the LV information table according to the second embodiment. An LV information table 240 indicates that LVs for transfer performance measurement having an LV name of “PF0000”, an LV name of “PF0001”, an LV name of “PF0002” and an LV name of “PF0003” are created. All of the LVs for transfer performance measurement are included in an LV group having a group name of “PERFORM”, which is an LV group for transfer performance measurement. The LV PF0000 and the LV PF0001 are LVs for transfer performance measurement and have an LV size of “100 MB”, respectively. The LV A00000 having the same LV size is an original LV. The original LV indicates a creation source of pseudo data. The LV information table 240 indicates that among the LVs for transfer performance measurement created from the LV A00000, the data of the LV PF0000 is preserved in a tape medium preservation place LIB-R TR0000 by the transfer performance measurement process. It is also indicated that the data of the LV PF0001 is preserved in a tape medium preservation place LIB-R TR0001.

The LV PF0002 and the LV PF0003 are LVs for transfer performance measurement and have an LV size of “200 MB”, respectively. The LV A00001 having the same size is an original LV. The LV information table 240 indicates that among the LVs for transfer performance measurement created from the LV A00001, the data of the LV PF0002 is preserved in the tape medium preservation place LIB-R TR0000 by the transfer performance measurement process. It is also indicated that the data of the LV PF0003 is preserved in the tape medium preservation place LIB-R TR0001.

When the transfer performance measurement is performed with varying the multiplicity level, the virtual tape device 11 may create a single LV for transfer performance measurement from a single original LV, or create two or more LVs for transfer performance measurement from a single original LV.

Next, an LV group information table updated by the transfer performance measurement process is illustrated in FIG. 11. FIG. 11 is a diagram illustrating another example of the LV group information table according to the second embodiment. An LV group information table 250 indicates that LV PF0000 and LV PF0001, . . . are included in the LV group PERFORM. The LV group information table 250 indicates that the LVs for transfer performance measurement included in the LV group PERFORM are assigned to tape media ranging from “LIB-R TR0000” to “LIB-R TR0999”. A permitted user name of “−” associated with the LV group PERFORM indicates that a permission for accessing the LV group PERFORM has not been given to any users.

As described above, the virtual tape device 11 may store LVs for transfer performance measurement in LIB-R by performing the transfer performance measurement process. Since accessing the LVs for transfer performance measurement stored in LIB-R is restricted, the LVs for transfer performance measurement stored in LIB-R are not accessed by a device other than the virtual tape device 11.

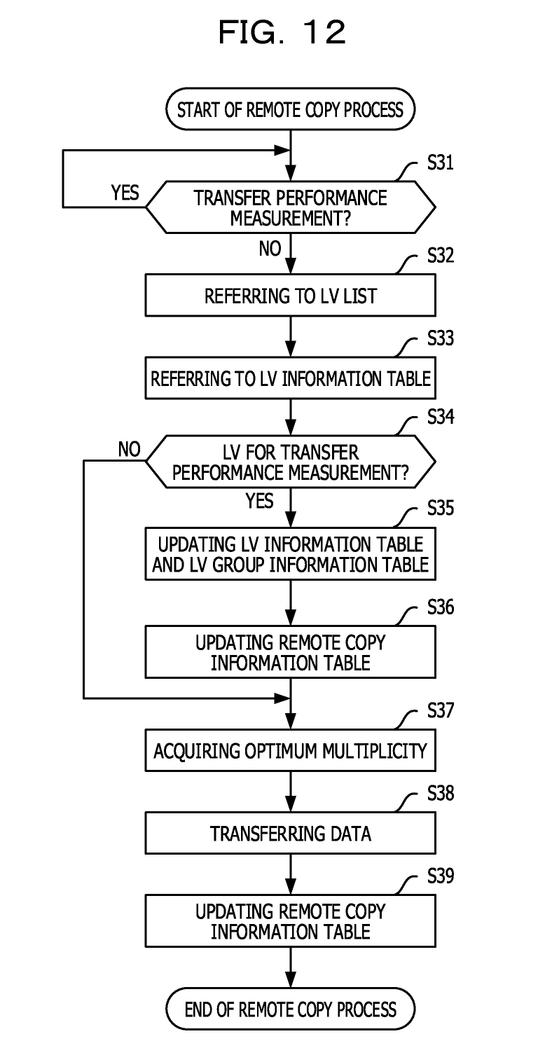

Next, descriptions will be made on a remote copy process according to the second embodiment with reference to FIG. 12. FIG. 12 is a flowchart illustrating the remote copy process according to the second embodiment. The remote copy process is a process in which a remote copy is performed from the virtual tape device 11 serving as a data transfer source to the virtual tape device 12 serving as a data transfer destination. The virtual tape device 11 receives a remote copy instruction from the host 13 to perform the remote copy process. The virtual tape device 11 performs the remote copy process according to an LV list notified along with the remote copy instruction. For example, the host 13 instructs the virtual tape device 11 to perform the remote copy process at a timing for backing up data stored in the virtual tape device 11 to the virtual tape device 12, for example, after a normal business hours. The computer 100 functions as a copy control unit which controls the remote copy process.

(S31) The virtual tape device 11 determines whether the transfer performance measurement is being performed. When it is determined that the transfer performance measurement is being performed, the virtual tape device 11 waits for the completion (including stopping) of the transfer performance measurement and proceeds to S32. In the transfer performance measurement process, the virtual tape device 11 stops the transfer performance measurement when the remote copy process is being performed. However, the virtual tape device 11 may also stop the transfer performance measurement in the remote copy process.

(S32) The virtual tape device 11 refers to the LV list.

(S33) The virtual tape device 11 refers to the LV information table.

(S34) The virtual tape device 11 determines whether an LV for the transfer performance measurement is present, of which original LV is listed in the LV list. For example, when the LV A00000 is present in the LV list, the LV PF0000 for transfer performance measurement and the LV PF0001 for transfer performance measurement are present in the LV information table 240, as LVs of which original LV is the LV A00000. Accordingly, in this case, the virtual tape device 11 determines that an LV for the transfer performance measurement is present, of which original LV is listed in the LV list.

When it is determined that an LV for the transfer performance measurement is present, of which original LV is listed in the LV list, the virtual tape device 11 proceeds to S35. When it is determined that an LV for the transfer performance measurement is not present, of which original LV is listed in the LV list, the virtual tape device 11 proceeds to S37.

(S35) The virtual tape device 11 changes the LVs for the transfer performance measurement, of which original LVs are present in the LV list, into the respective original LVs, thereby updating the LV information table. For example, when the LV A00000 is present in the LV list, the virtual tape device 11 changes the LV name of the LV PF0000 for the transfer performance measurement in the LV information table 240 into “A00000”. That is, the virtual tape device 11 uses the LV for the transfer performance measurement preserved in the virtual tape device 12 as the original LV copied to the virtual tape device 12 by renaming the preserved LV. The virtual tape device 11 updates the “member LV name” field of the LV group information table according to the updating of the LV information table.

Accordingly, the data of the LV A00000 is preserved in the tape medium preservation place LIB-R TR0000 and the data transfer thereof in the remote copy process is not required.

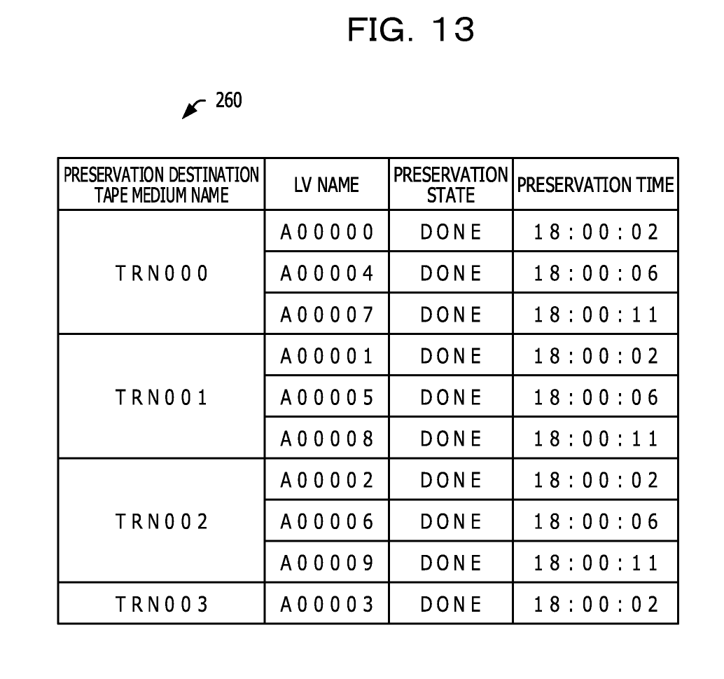

(S36) The virtual tape device 11 updates a remote copy information table. The remote copy information table contains data, such as a preservation destination, a preservation state, and a preservation time, regarding an LV copied in the remote copy process. The virtual tape device 11 writes a preservation destination, a preservation state, and a preservation time of an LV which has been substituted for the LV for transfer performance measurement. The remote copy information table will be described later with reference to FIG. 13.

(S37) The virtual tape device 11 acquires, from the transfer performance data table 230, a multiplicity level (optimum multiplicity) which is optimum for transferring data to be transferred. The optimum multiplicity corresponds to a multiplicity level which is smaller by 1 (one) than that of a multiplicity level by which the performance limit is confirmed. For example, when an LV size of the data to be transferred is “50 MB”, multiplicity level “5” in the transfer performance data table 230 is the multiplicity level which is smaller by 1 (one) than multiplicity level “6” by which the performance limit is confirmed.

(S38) The virtual tape device 11 performs the transfer of LVs listed in the LV list with the optimum multiplicity, except for the LVs involved in the renaming in S35.

(S39) The virtual tape device 11 updates the remote copy information table. The virtual tape device 11 writes a preservation destination, a preservation state, and a preservation time of the LV transferred with the optimum multiplicity. Upon updating the remote copy information table, the virtual tape device 11 ends the remote copy process.

As described above, an efficient remote copy may be performed since the virtual tape device 11 is able to regard the test data at the time of the transfer performance measurement as data to be transferred for remote copy in addition to performing the remote copy with the optimum multiplicity.

Accordingly, the virtual tape device 11 may perform a remote copy in which a bandwidth of the WDM 14 is efficiently used. An efficient use of the bandwidth of the WDM 14 enables a remote copy in a narrower band and may reduce the communication cost incurred from the operation of the data transfer system 10.

The virtual tape device 11 may also achieve reduction of a processing time of the remote copy. The reduction of the processing time of the remote copy contributes to an efficiency of a process performed at a time other than business hours of A-center and may reduce the operation cost of the data transfer system 10 in addition to extending business hours of A-center. The reduction of the processing time of the remote copy through an efficient use of the bandwidth of the WDM 14 reduces the risk of data transfer failure during the data transfer processing.

Next, a remote copy information table updated by the remote copy process is illustrated in FIG. 13. FIG. 13 is a diagram illustrating an example of a remote copy information table according to the second embodiment. The remote copy information table 260 contains “LV name”, “preservation destination tape medium name”, “preservation state”, and “preservation time” as field items. An LV name is a name of an LV present in the LV list. A preservation destination tape medium name is a name of a tape medium in which the LV is preserved. A preservation state is a state of the LV in the remote copy process. A preservation time is a time at which the LV is preserved. For example, the remote copy information table 260 indicates that copy of the LV A00000 is “DONE” and the LV A00000 is preserved in a tape medium having a name of “TRN000” at “18:00:02”. The preservation state may include, for example, “ERROR” indicating an error state, “COPYING” indicating that copy is being performed and “WAITING” indicating that copy is to be performed, in addition to the “DONE” indicating completion of copy.

The remote copy information table 260 indicates that the remote copy process is normally completed, since all of the preservation states are “DONE”. The virtual tape device 11 notifies the host 13 of the completion of the remote copy process. The host 13 notifies the virtual tape device 12 of the LV list, so that the virtual tape device 12 recognizes the LV transferred to LIB-R. All of the remote copy ends after the virtual tape device 12 completes copy of the LV from LIB-R to LIB-B.

The processing function described in the second embodiment is only required to be installed in the virtual tape device 11 serving as a transfer source for data transfer and is not required to be installed in the virtual tape device 12 serving as a transfer destination for data transfer. Accordingly, the data transfer system 10 may reduce a cost burden of changing a system from a conventional data transfer system.

The processing function described above may be implemented by a computer. In such a case, a program is provided that describes the processing function to be installed in the virtual tape device 11. When the computer executes the program, the processing function described above is implemented in the computer. The virtual tape device 12 may also implement the processing function of the second embodiment by applying the matters described above similarly as in the virtual tape device 11. The data transfer control device 1 according to the first embodiment may also implement the processing function of the first embodiment by applying the matters described above similarly as in the virtual tape device 11.

The program in which the processing function to be installed is described may be recorded in a computer-readable recording medium. The computer computer-readable recording medium may include, for example, a magnetic storage device, an optical disk, an opto-magnetic recording medium, and a semiconductor memory. The magnetic storage device may include, for example, a hard disk drive (HDD), a flexible disk (FD) or a magnetic tape. The optical disk may include, for example, a digital versatile disc (DVD), a DVD-RAM or a CD-ROM/RW. The opto-magnetic recording medium may include, for example, a magneto-optical disk (MO).

A program may be distributed in a portable recording medium such as a DVD or a CD-ROM in which the program is recorded. The program may be stored in a storage device of a server computer and transferred from the server computer to other computer via a network.

A computer which executes a program stores, for example, a program recorded in the recording medium or a program transferred from the server computer, in the storage device of its own. The computer reads the program from the storage device of its own and performs a processing according to the program. The computer may read the program directly from the portable recording medium and perform the processing according to the program. The computer may perform the processing sequentially according to the received program, each time the program is transferred from the server computer connected via a network.

At least some of processing function described above may be realized by an electronic circuit such as a digital signal processor (DSP), an application specific integrated circuit (ASIC), or a programmable logic device (PLD).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A data transfer control device, comprising:
a processor configured to
measure a data transfer performance for each number of destination recording media, the data transfer performance being a performance for copying test data from a first storage device to a second storage device connected to the first storage device through a line, the destination recording media being included in the second storage device and serving as copy destinations of the copying,
determine a first number of destination recording media on basis of the data transfer performance measured for each number of destination recording media, and
control a remote copy of copying data from the first storage device to the second storage device, the remote copy being performed by using the first number of destination recording media.

2. The data transfer control device according to claim 1, wherein
the processor is configured to
control the remote copy to be performed in preference to the measurement of the data transfer performance.

3. The data transfer control device according to claim 1, wherein
the processor is configured to
measure the data transfer performance when the first storage device receives data having possibilities of being subject to the remote copy.

4. The data transfer control device according to claim 1, wherein
the processor is configured to
create the test data from first data having possibilities of being subject to the remote copy.

5. The data transfer control device according to claim 4, wherein
the first data is received by the first storage device to write in the first storage device.

6. The data transfer control device according to claim 4, wherein
the processor is configured to
use the test data copied to the second storage device as the first data copied to the second storage device by renaming the copied test data without copying the first data, if the first data is subject to the remote copy and if the test data has been copied to the second storage device before the remote copy is performed.

7. A computer-readable recording medium having stored therein a program for causing a computer to execute a process, the process comprising:
measuring a data transfer performance for each number of destination recording media, the data transfer performance being a performance for copying test data from a first storage device to a second storage device connected to the first storage device through a line, the destination recording media being included in the second storage device and serving as copy destinations of the copying;
determining a first number of destination recording media on basis of the data transfer performance measured for each number of destination recording media; and
controlling a remote copy of copying data from the first storage device to the second storage device, the remote copy being performed by using the first number of destination recording media.

8. A method for controlling data transfer, the method comprising:
measuring, by a computer, a data transfer performance for each number of destination recording media, the data transfer performance being a performance for copying test data from a first storage device to a second storage device connected to the first storage device through a line, the destination recording media being included in the second storage device and serving as copy destinations of the copying;
determining a first number of destination recording media on basis of the data transfer performance measured for each number of destination recording media; and
controlling a remote copy of copying data from the first storage device to the second storage device, the remote copy being performed by using the first number of destination recording media.
